(19) United States
(12) Patent Application Publication
(10) Pub. No.: US 2018/0274477 A1
(43) Pub. Date: Sep. 27, 2018

(54) CYLINDER HEAD FOR INTERNAL COMBUSTION ENGINE

(71) Applicant: TOYOTA JIDOSHA KABUSHIKI KAISHA, Toyota-shi (JP)

(72) Inventors: Masao NAKAYAMA, Nagoya-shi (JP); Masahiko ASANO, Toyota-shi (JP)

(73) Assignee: TOYOTA JIDOSHA KABUSHIKI KAISHA, Toyota-shi (JP)

(21) Appl. No.: 15/921,895

(22) Filed: Mar. 15, 2018

(30) Foreign Application Priority Data
Mar. 21, 2017 (JP) 2017-055067

(51) Int. Cl. F02F 1/40; F01P 3/02; F02F 1/42

(52) U.S. Cl. CPC F02F 1/40; F01P 2003/024; F02F 1/4285; F01P 3/02

(57) ABSTRACT

A cylinder head in an internal combustion engine includes a cylinder head main body in which a plurality of combustion chambers is arranged and a pipe member that extends along a direction in which the combustion chambers are arranged, through which a refrigerant flows, and which is embedded in the cylinder head main body. The pipe member is provided with a curved portion that is curved and the curved portion is provided with a throttle region in which a sectional area is partially reduced.

### INCORPORATION BY REFERENCE

The disclosure of Japanese Patent Application No. 2017-055067 filed on Mar. 21, 2017 including the specification, drawings and abstract is incorporated herein by reference in its entirety.

### BACKGROUND

### 1. Technical Field

The present disclosure relates to a cylinder head for an internal combustion engine.

### 2. Description of Related Art

A cylinder head is known, in which a water jacket formed by a pipe member is embedded in order to suppress a temperature rise in a combustion chamber provided in the cylinder head for an internal combustion engine. The pipe member extends along a plurality of combustion chambers arranged in the cylinder head and is provided with a curved portion that is partially curved in order to avoid interference with an exhaust port or an ignition plug (for example, refer to Japanese Unexamined Patent Application Publication No. 2001-207844 (JP 2001-207844 A)).

### SUMMARY

In the curved portion, there may be a decrease in flow rate due to an increase in refrigerant pressure drop. Therefore, there is a possibility that the combustion chambers cannot be effectively cooled and the temperatures of the combustion chambers become high.

The disclosure provides a cylinder head for an internal combustion engine in which a temperature rise in a combustion chamber is more effectively suppressed.

An aspect of the disclosure relates to a cylinder head for an internal combustion engine. The cylinder head includes a cylinder head main body and pipe members. In the cylinder head main body, a plurality of combustion chambers is arranged. The pipe member extends along a direction in which the combustion chambers are arranged, a refrigerant flows through the pipe member, and the pipe member is embedded in the cylinder head main body. The pipe member is provided with a first curved portion that is curved and the first curved portion is provided with a first throttle region. A sectional area of the first throttle region is partially reduced.

According to the aspect of the disclosure, since the first throttle region is provided in the first curved portion, a decrease in flow rate in the first curved portion is suppressed and a temperature rise in the first combustion chamber is suppressed.

In the cylinder head according to the aspect of the disclosure, the combustion chamber may include a first combustion chamber which is closest to the first curved portion. The first curved portion may be curved to be close to the first combustion chamber.

In the cylinder head according to the aspect of the disclosure, a first wall portion of the first curved portion may be provided with a first thin portion, which faces the first combustion chamber, and which is thinner than another portion.

In the cylinder head according to the aspect of the disclosure, at least a portion of the first thin portion may be provided in the first throttle region.

In the cylinder head according to the aspect of the disclosure, the combustion chambers may further include a second combustion chamber that is adjacent to the first combustion chamber and that is downstream or upstream of the first combustion chamber in a flowing direction of the refrigerant, the pipe member is further provided with a second curved portion that is closest to the second combustion chamber, the second curved portion is provided with a second throttle region, and a path sectional area at the second throttle region is smaller than a path sectional area at the first throttle region.

In the cylinder head according to the aspect of the disclosure, the combustion chambers may further include a second combustion chamber that is adjacent to the first combustion chamber and that is downstream or upstream of the first combustion chamber in a flowing direction of the refrigerant, the pipe member is further provided with a second curved portion that is closest to the second combustion chambers, a second wall portion of the second curved portion is provided with a second thin portion which is thinner than the first thin portion.

In the cylinder head according to the aspect of the disclosure, the first curved portion may be positioned between two exhaust ports that communicate with the first combustion chamber, and the second curved portion may be positioned between two exhaust ports that communicate with the second combustion chamber.

In the cylinder head according to the aspect of the disclosure, the first curved portion may be positioned between two intake ports that communicate with the first combustion chamber, and the second curved portion may be positioned between two intake ports that communicate with the second combustion chamber.

In the cylinder head according to the aspect of the disclosure, the pipe members may include a first pipe member and a second pipe member that are disposed such that an ignition plug is interposed between the first pipe member and the second pipe member in a top view.

According to the aspect of the disclosure, it is possible to provide a cylinder head for an internal combustion engine in which a temperature rise in a combustion chamber is suppressed.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is an explanatory view of a refrigerant flow path in an engine system;

FIG. 2 is a sectional view of a cylinder head;

FIG. 3A is a sectional view illustrating the vicinity of a curved portion;

FIG. 3B is a sectional view illustrating the vicinity of a curved portion;

FIG. 4A is a sectional view illustrating the vicinity of a curved portion;

FIG. 4B is a sectional view illustrating the vicinity of a curved portion;

FIG. 5A is a sectional view illustrating the vicinity of a curved portion;

FIG. 5B is a sectional view illustrating the vicinity of a curved portion;

FIG. 6A is a sectional view illustrating the vicinity of a curved portion; and

FIG. 6B is a sectional view illustrating the vicinity of a curved portion.

### DETAILED DESCRIPTION OF EMBODIMENTS

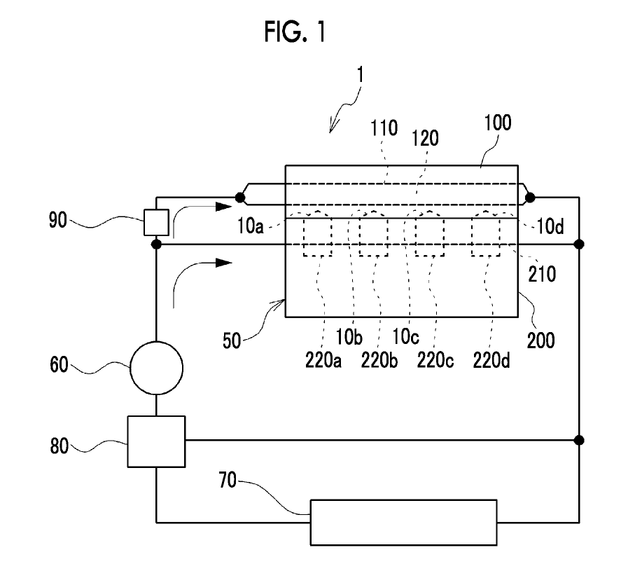

FIG. 1 is an explanatory view of a refrigerant flow path in an engine system 1. The engine system 1 is provided with an engine 50, a water pump 60, a radiator 70, a thermostat 80, and a flow control valve 90. The engine 50 is provided with a cylinder block 200 and a cylinder head 100 that is disposed above the cylinder block 200. In the cylinder block 200, cylinders 220a to 220d arranged in one direction are formed. In the cylinder head 100, combustion chambers 10a to 10d that respectively correspond to the cylinders 220a to 220d are formed. In each of the cylinders 220a to 220d, a piston (not shown) is accommodated such that the piston can reciprocate. In the cylinder block 200, a water jacket 210 extending around the cylinders 220a to 220d is formed. In the cylinder head 100, pipe members 110, 120 are embedded.

A refrigerant is split according to the opening degree of the flow control valve 90 after being discharged from the water pump 60 and a portion of the refrigerant flows through the pipe members 110, 120 of the cylinder head 100 and the remainder of the refrigerant flows through the water jacket 210 of the cylinder block 200. Refrigerants discharged from the cylinder head 100 and the cylinder block 200 join each other and return to the water pump 60 via the thermostat 80 or return to the water pump 60 via the radiator 70 and the thermostat 80. The engine 50 is cooled when the refrigerant flows through the pipe members 110, 120 or the water jacket 210.

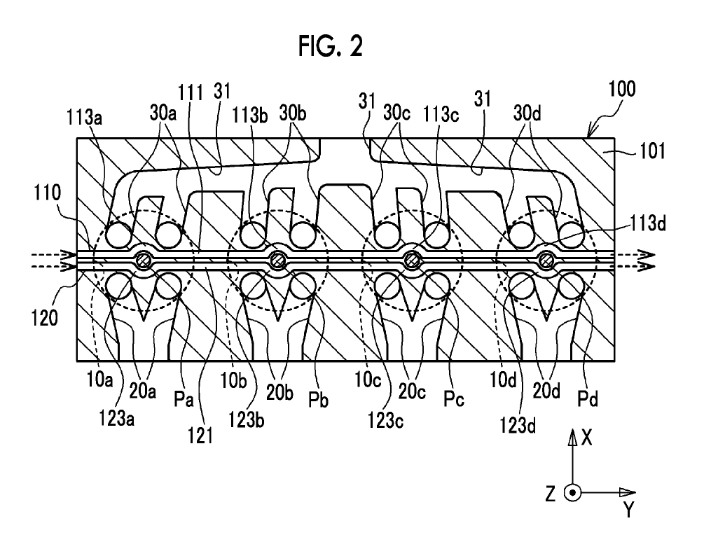

Next, the cylinder head 100 will be described. FIG. 2 is a sectional view of the cylinder head 100. FIG. 2 illustrates a section that is orthogonal to an axial direction of each of the cylinders 220a to 220d that define the combustion chambers 10a to 10d. In other words, FIG. 2 illustrates a section that is orthogonal to a reciprocating direction of the piston. In FIG. 2, a Y-axis direction is a direction in which the combustion chambers 10a to 10d are arranged and an X-axis direction is a direction from intake ports 20a to 20d to exhaust ports 30a to 30d. The X-axis direction and the Y-axis direction correspond to a horizontal direction and a Z-axis direction corresponds to a vertical direction. The section in FIG. 2 is a section as seen from a vertically upper side. Accordingly, the combustion chambers 10a to 10d are positioned closer to the back side of the paper surface than the section in FIG. 2.

The cylinder head 100 includes a cylinder head main body 101 that is an aluminum alloy casting and the pipe members 110, 120 that are embedded in the cylinder head main body 101. The combustion chambers 10a to 10d, the intake ports 20a to 20d, the exhaust ports 30a to 30d, and an exhaust manifold 31 are formed in the cylinder head main body 101. Ignition plugs Pa to Pd are disposed at the respective central positions in the combustion chambers 10a to 10d. The exhaust ports 30a to 30d respectively communicate with the combustion chambers 10a to 10d. The exhaust manifold 31 communicates with the exhaust ports 30a to 30d. The number of each of the exhaust ports 30a to 30d is two and the exhaust ports 30a to 30d are opened and closed by an exhaust valve (not shown). The intake ports 20a to 20d respectively communicate with the combustion chambers 10a to 10d. The number of each of the intake ports 20a to 20d is two and the intake ports 20a to 20d are opened and closed by an intake valve (not shown).

Each of the pipe members 110, 120 is a pipe formed of an aluminum alloy and the pipe members 110, 120 extend along each other in a direction in which the combustion chambers 10a to 10d are arranged. A flowing direction in which the refrigerant flows in the pipe member 110 and a flowing direction in which the refrigerant flows in the pipe member 120 are the same as each other. The shape of a section of each of the pipe members 110, 120 is an approximately perfect circle-like shape. However, the invention is not limited to this and the shape of the section may be an oval shape. The pipe member 110 is disposed between the ignition plugs Pa to Pd and the exhaust ports 30a to 30d. The pipe member 120 is disposed between the ignition plugs Pa to Pd and the intake ports 20a to 20d. The pipe members 110, 120 are positioned vertically above the combustion chambers 10a to 10d and the combustion chambers 10a to 10d are cooled by the refrigerants flowing in the pipe members 110, 120.

Specifically, the pipe member 110 is provided with an approximately linearly extending main body portion 111, and curved portions 113a to 113d that are partially formed on the main body portion 111. The curved portion 113a protrudes between the two exhaust ports 30a and is curved to avoid the ignition plug Pa. The same applies to the curved portions 113b to 113d, the exhaust ports 30b to 30d, and the ignition plugs Pb to Pd. Therefore, when the refrigerant flows through the pipe member 110, a temperature rise in the vicinity of the exhaust ports 30a to 30d and the ignition plugs Pa to Pd is further suppressed.

The pipe member 120 is provided with an approximately linearly extending main body portion 121, and curved portions 123a to 123d that are partially formed on the main body portion 121. The curved portion 123a protrudes between the two intake ports 20a and is curved to avoid the ignition plug Pa. The same applies to the curved portions 123b to 123d, the intake ports 20b to 20d, and the ignition plugs Pb to Pd. Therefore, when the refrigerant flows through the pipe member 120, a temperature rise in the vicinity of the intake ports 20a to 20d and the ignition plugs Pa to Pd is further suppressed.

The intake ports 20a and the exhaust ports 30a communicate with the combustion chamber 10a. Similarly, the intake ports 20b to 20d and the exhaust ports 30b to 30d respectively communicate with the combustion chambers 10b to 10d. Therefore, a temperature rise in the combustion chambers 10a to 10d is also suppressed as with the intake ports 20a to 20d and the exhaust ports 30a to 30d. Furthermore, as described above, the pipe members 110, 120 are disposed such that the ignition plugs Pa to Pd are interposed between the pipe members 110, 120. Therefore, a temperature rise in the vicinity of the ignition plugs Pa to Pd is further suppressed.

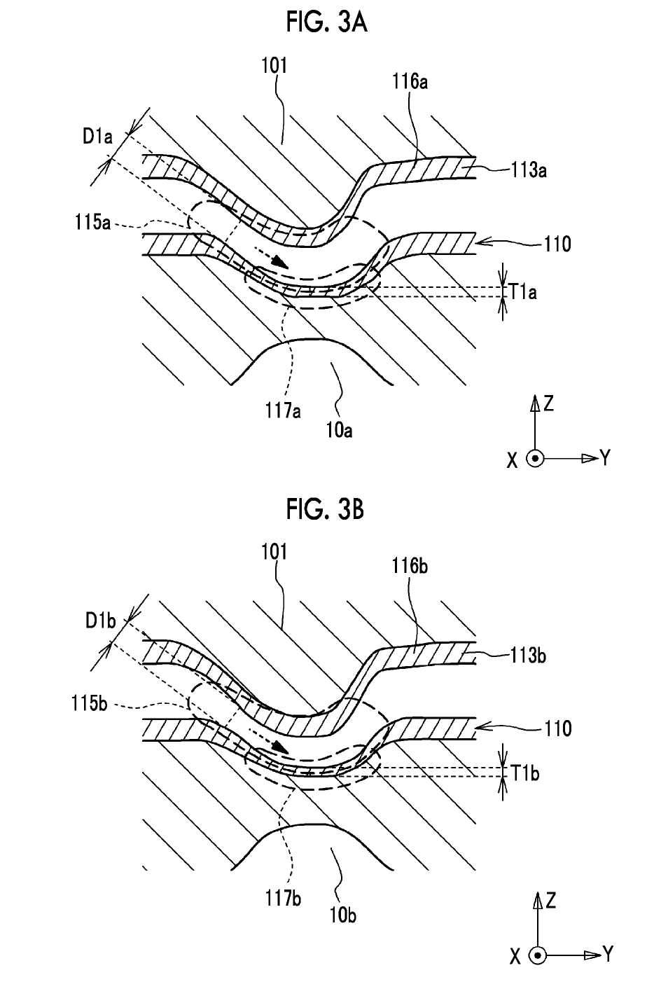

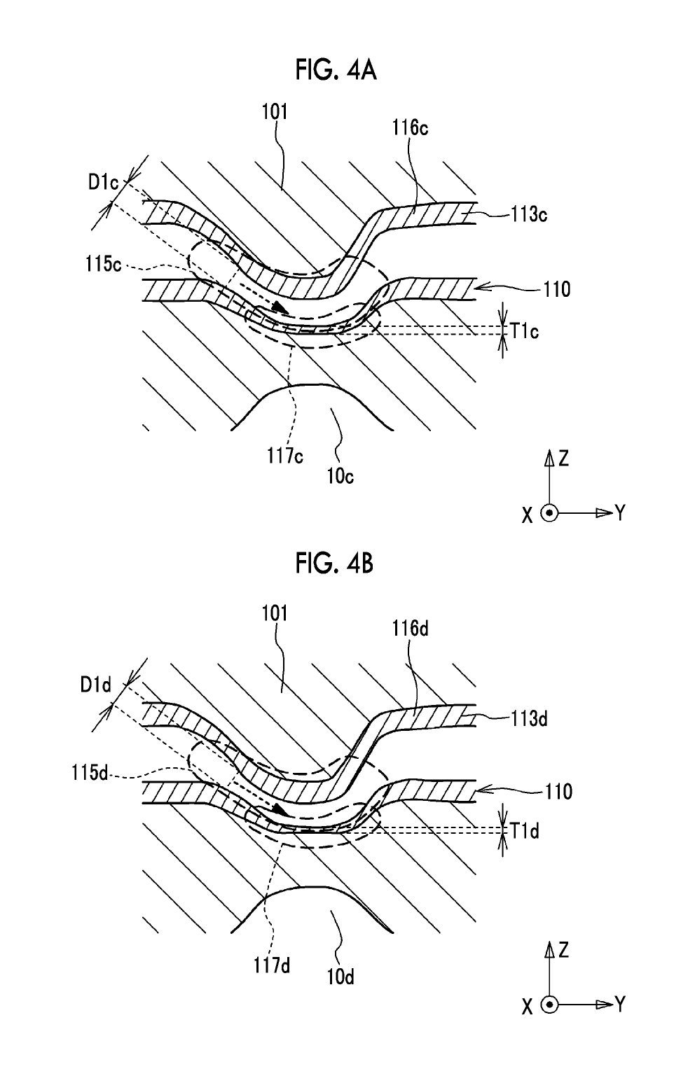

Next, the curved portions 113a to 113d of the pipe member 110 will be described in detail. FIG. 3A, FIG. 3B, FIG. 4A, and FIG. 4B are respectively sectional views illustrating the vicinity of the curved portions 113a to 113d. FIGS. 3A to 4B illustrate sections orthogonal to the X-axis direction. The lower side in each of FIGS. 3A to 4B is a vertically lower side and is a side on which the cylinder block 200 is disposed. As illustrated in FIGS. 3A to 4B, the curved portions 113a to 113d are curved to protrude toward the vertically lower side. As illustrated in FIG. 2, the curved portions 113a to 113d are also curved in the horizontal direction. Therefore, the curved portions 113a to 113d are curved in the horizontal direction and are curved toward the vertically lower side.

As illustrated in FIG. 3A, the curved portion 113a is curved toward the vertically lower side such that the curved portion 113a becomes closer to the combustion chamber 10a that is closest to the curved portion 113a among the combustion chambers 10a to 10d. With the refrigerant flowing through the curved portion 113a that is curved to become close to the combustion chamber 10a as described above, it is possible to suppress a temperature rise in the combustion chamber 10a.

In the curved portion 113a, a throttle region 115a having a smaller path sectional area than that of another portion is formed over a predetermined area. The throttle region 115a is provided in the curved portion 113a. Specifically, in the throttle region 115a, the path sectional area gradually decreases from an upstream side, the path sectional area becomes approximately constant after the decrease, and the path sectional area gradually increases to reach the original path sectional area at a downstream side. The decrease and the increase in path sectional area are realized by a decrease and an increase in inner diameter. The shape of the section at the throttle region 115a is maintained at the approximately perfect circle-like shape. However, the invention is not limited to this and the shape of the section at the throttle region 115a may be maintained at an approximately circular shape including an oval shape or a perfect circle-like shape. Accordingly, the resistance to the refrigerant is suppressed. The shape of the section at the curved portion 113a other than the throttle region 115a or the main body portion 111 is also maintained at an approximately circular shape including an oval shape or a perfect circle-like shape. The throttle region 115a may have a shape such that the path sectional area of the throttle region 115a is minimized at an intermediate position between the upstream side and the downstream side, the path sectional area gradually decreases from the upstream side toward the intermediate position, and the path sectional area gradually increases from the intermediate position to the downstream side.

Since the path sectional area is partially reduced, the flow rate of a fluid increases at a portion with a reduced path sectional area in comparison with a case where the path sectional area is constant at all times. Therefore, a decrease in flow rate of the refrigerant flowing through the curved portion 113a provided with the throttle region 115a is suppressed in comparison with a case where the throttle region 115a is not provided. Therefore, a temperature rise in the combustion chamber 10a is more effectively suppressed. In FIG. 3A, a diameter D1a at the throttle region 115a is illustrated.

A wall portion of the curved portion 113a is provided with a thick portion 116a and a thin portion 117a that is formed to be thinner than the thick portion 116a. The thin portion 117a is formed at a position facing the combustion chamber 10a. Therefore, transmission of heat from the combustion chamber 10a to the refrigerant is promoted via the thin portion 117a and a temperature rise in the combustion chamber 10a is more effectively suppressed with the refrigerant flowing along the thin portion 117a.

At least a portion of the thin portion 117a is formed in the throttle region 115a. Therefore, since the refrigerant of which a decrease in flow rate is suppressed flows along the thin portion 117a, it is possible to more effectively suppress a temperature rise in the combustion chamber 10a.

Similarly, as illustrated in FIGS. 3B, 4A, and 4B, the curved portions 113b to 113d are respectively provided with throttle regions 115b to 115d, thick portions 116b to 116d, and thin portions 117b to 117d and a temperature rise in the combustion chambers 10b to 10d is more effectively suppressed. The throttle regions 115a to 115d are respectively formed in the curved portions 113a to 113d and a decrease in flow rate of the refrigerant is suppressed. Accordingly, a decrease in flow rate of the refrigerant in the entire pipe member 110 is also suppressed and a temperature rise in the entire combustion chambers 10a to 10d is more effectively suppressed.

The respective diameters D1a to D1d of the throttle regions 115a to 115d descend in this order: the diameter D1a, the diameter D1b, the diameter D1c, and the diameter D1d. Therefore, the flow rates of the refrigerants flowing in the throttle regions 115a to 115d ascend in this order: the throttle region 115a, the throttle region 115b, the throttle region 115c, and the throttle region 115d. As described above, the flow rate of the refrigerant flowing on the downstream side in the curved portion is higher than that of the refrigerant flowing on the upstream side in the curved portion.

Since the refrigerant receives heat from each combustion chamber when flowing from the upstream side to the downstream side, the temperature of the refrigerant increases toward the downstream side. Therefore, in a case where the flow rates of refrigerants respectively flowing in the curved portions 113a to 113d are the same as each other, the cooling efficiency of the refrigerant decreases toward the downstream side and the temperature ascends in this order: the combustion chamber 10a, the combustion chamber 10b, the combustion chamber 10c, and the combustion chamber 10d. Therefore, there is a possibility that the temperature in the combustion chambers 10a to 10d varies. In this embodiment, the variation in temperature in the combustion chambers 10a to 10d is suppressed since the flow rates of the refrigerants flowing in the throttle regions 115a to 115d ascend in this order: the throttle region 115a, the throttle region 115b, the throttle region 115c, and the throttle region 115d.

The respective thicknesses T1a to T1d of the thin portions 117a to 117d descend in this order: the thickness T1a, the thickness T1b, the thickness T1c, and the thickness T1d. The variation in temperature in the combustion chambers 10a to 10d is also suppressed due to the above-described point.

As described above, since the variation in temperature in the combustion chambers 10a to 10d is suppressed, it is possible to effectively suppress a possibility of knocking or the like in a combustion chamber with a relatively high temperature.

Although the thin portions 117a to 117d are thin, a decrease in strength of the pipe member 110 is suppressed since the thick portions 116a to 116d are thick.

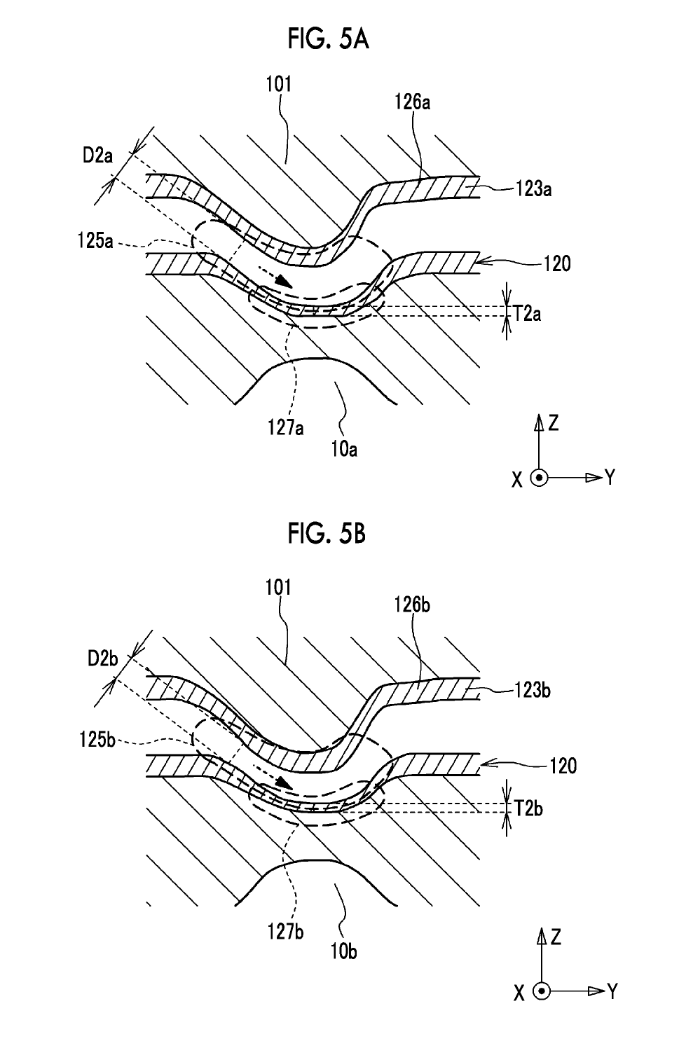

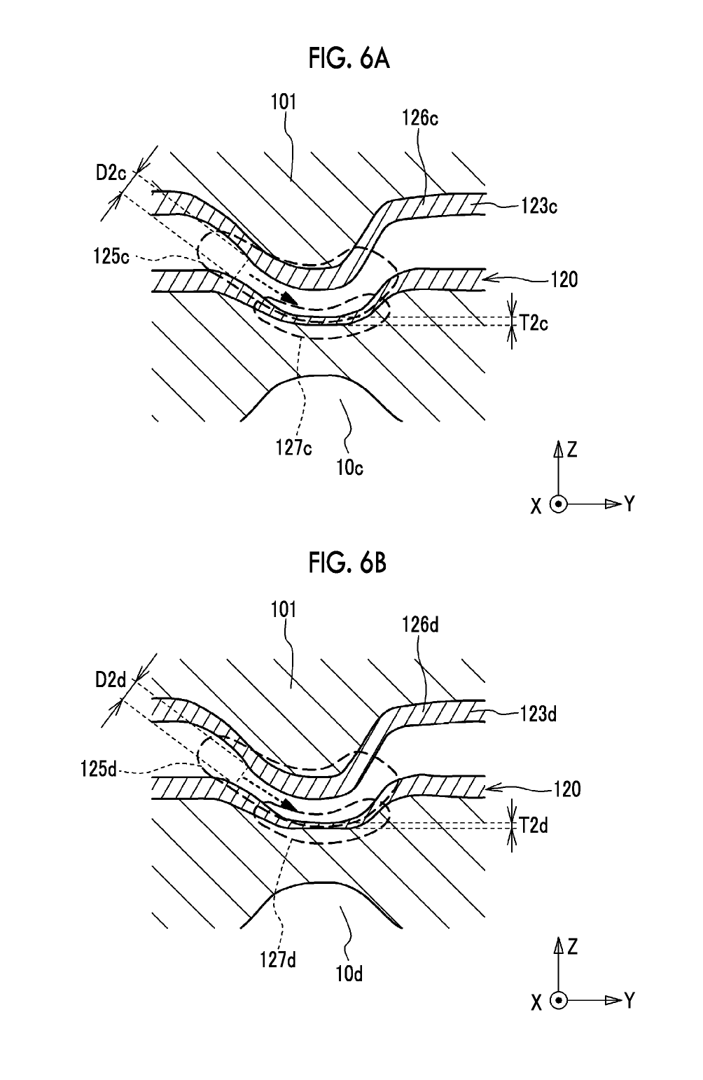

Next, the curved portions 123a to 123d of the pipe member 120 will be described. Since the curved portions 123a to 123d have similar configurations as those of the curved portions 113a to 113d, the description will be simplified. FIG. 5A, FIG. 5B, FIG. 6A, and FIG. 6B are respectively sectional views illustrating the vicinity of the curved portions 123a to 123d. FIGS. 5A to 6B illustrate sections orthogonal to the X-axis direction. The lower side in each of FIGS. 5A to 6B is the vertically lower side and is the side on which the cylinder block 200 is disposed. As illustrated in FIGS. 5A to 6B, and FIG. 2, the curved portions 123a to 123d are curved in the horizontal direction and are curved toward the vertically lower side.

As illustrated in FIG. 5A, since the curved portion 123a is curved toward the vertically lower side such that the curved portion 123a becomes closer to the combustion chamber 10a that is closest to the curved portion 123a among the combustion chambers 10a to 10d, a temperature rise in the combustion chamber 10a is more effectively suppressed with the refrigerant flowing through the curved portion 123a. In addition, in the curved portion 123a, a throttle region 125a having a smaller path sectional area than that of another portion is formed over a predetermined area. Accordingly, a decrease in flow rate of the refrigerant is suppressed, and thus a temperature rise in the combustion chamber 10a is more effectively suppressed. In FIG. 5A, a diameter D2a at the throttle region 125a is illustrated.

A wall portion of the curved portion 123a is provided with a thick portion 126a and a thin portion 127a that is formed to be thinner than the thick portion 126a and the thin portion 127a faces the combustion chamber 10a. Therefore, a temperature rise in the combustion chamber 10a is more effectively suppressed with the refrigerant flowing along the thin portion 127a. At least a portion of the thin portion 127a is formed in the throttle region 125a. Therefore, since the refrigerant of which a decrease in flow rate is suppressed flows along the thin portion 127a, a temperature rise in the combustion chamber 10a is more effectively suppressed.

Similarly, as illustrated in FIGS. 5B, 6A, and 6B, the curved portions 123b to 123d are respectively provided with throttle regions 125b to 125d, thick portions 126b to 126d, and thin portions 127b to 127d and a temperature rise in the combustion chambers 10b to 10d is more effectively suppressed. The throttle regions 125a to 125d are respectively formed in the curved portions 123a to 123d and a decrease in flow rate of the refrigerant is suppressed. Accordingly, a decrease in flow rate of the refrigerant in the entire pipe member 120 is suppressed and a temperature rise in the combustion chambers 10a to 10d is more effectively suppressed. As illustrated in FIG. 2, the curved portions 123a to 123d are also curved in the horizontal direction. Therefore, the curved portions 123a to 123d are curved in the horizontal direction and are curved toward the vertically lower side.

As with the pipe member 110, the pipe member 120 is formed such that the respective diameters D2a to D2d of the throttle regions 125a to 125d descend in this order: the diameter D2a, the diameter D2b, the diameter D2c, and the diameter D2d. Therefore, the flow rates of the refrigerants flowing in the throttle regions 125a to 125d ascend in this order: the throttle region 125a, the throttle region 125b, the throttle region 125c, and the throttle region 125d. The thicknesses T2a to T2d of the thin portions 127a to 127d descend in this order: the thickness T2a, the thickness T2b, the thickness T2c, and the thickness T2d. Accordingly, the variation in temperature in the combustion chambers 10a to 10d is suppressed. Although the thin portions 127a to 127d are thin, a decrease in strength of the pipe member 120 is suppressed since the thick portions 126a to 126d are thick.

Next, a manufacturing process of the cylinder head 100 will be described. First, a core for forming the intake ports 20a to 20d, the exhaust ports 30a to 30d, and the exhaust manifold 31 and the pipe members 110, 120 are prepared. Next, the core and the pipe members 110, 120 are set in a cavity in a casting mold. Next, with a refrigerant such as air or water flowing into the pipe members 110, 120, the cavity is filled with molten metal at a pressure such that the molten metal does not flow into the pipe members 110, 120 and the core does not collapse. Thereafter, the molten metal is cooled and the molten metal is bonded to the pipe members 110, 120, and thus the cylinder head 100 is cast. After the cylinder head 100 is cast, the core is destroyed, discharged, and removed such that the cylinder head 100 in which the intake port 20a or the like is formed is manufactured.

As described above, the thin portion 117a is provided in the throttle region 115a and a decrease in flow rate of the refrigerant flowing along the thin portion 117a is suppressed even during the casting. Therefore, it is possible to efficiently cool the thin portion 117a and to suppress erosion of the thin portion 117a that occurs due to high-temperature molten metal. Similarly, it is possible to suppress erosion of the thin portions 117b to 117d.

The same applies to the pipe member 120. That is, the thin portion 127a is provided in the throttle region 125a and a decrease in flow rate of the refrigerant flowing along the thin portion 127a is suppressed even during the casting. Therefore, it is possible to efficiently cool the thin portion 127a and to suppress erosion of the thin portion 127a that occurs due to high-temperature molten metal. Similarly, it is possible to suppress erosion of the thin portions 127b to 127d.

For example, it is also conceivable to form a water jacket using a core. However, in a case of a complicated shape in which a plurality of curved portions is present as with the embodiment, there is a possibility that preparation is difficult. When a metal pipe member of which the shape can be easily processed in advance is used as in the embodiment, the degree of freedom in shape of the refrigerant flow path in the cylinder head 100 is secured.

Although the embodiment of the present invention has been described in detail above, the present invention is not limited to the specific embodiment described above, and various modifications and changes are possible within the scope of the gist of the present invention described in claims.

In the embodiment, a cylinder head for an inline four-cylinder engine has been described as an example. However, the invention is not limited to this. Any cylinder head with two or more linearly arranged combustion chambers may be used. A cylinder head for a diesel engine that does not include an ignition plug may also be used.

A configuration in which one of the pipe members 110, 120 is provided may also be adopted.

Any configuration may be adopted as long as at least one of the curved portions 113a to 113d is provided. The curved portion 113a is positioned at a position between the two exhaust ports 30a but a curved portion may be provided at a position other than the position between the two exhaust ports 30a. The same applies to the curved portions 123a to 123d.

The diameters D1a to D1d may be the same as each other. The diameters of a plurality of adjacent curved portions among the diameters D1a to D1d may be the same as each other and the diameter of a curved portion upstream of the adjacent curved portions may be greater than the diameters of the adjacent curved portions. Similarly, the diameters of the adjacent curved portions among the diameters D1a to D1d may be the same as each other and the diameter of a curved portion downstream of the adjacent curved portions may be smaller than the diameters of the adjacent curved portions. The thicknesses T1a to T1d may be the same as each other. The thicknesses of thin portions of the adjacent curved portions among the thicknesses T1a to T1d may be the same as each other and a thin portion of a curved portion upstream of the adjacent curved portions may be thicker than the adjacent curved portions. The thicknesses of thin portions of the adjacent curved portions among the thicknesses T1a to T1d may be the same as each other and a thin portion of a curved portion downstream of the adjacent curved portions may be thinner than the adjacent curved portions. The same applies to the diameters D2a to D2d and the thicknesses T2a to T2d.

The thin portions 117a to 117d may not be provided and the thicknesses of the wall portions of the curved portions 113a to 113d may be constant at all times. The thin portions 117b to 117d may be provided without the thin portion 117a. The thin portions 117c, 117d may be provided without the thin portions 117a, 117b. The thin portion 117d may be provided without the thin portions 117a to 117c. The same applies to the thin portions 127a to 127d.

At least one of the pipe members 110, 120 may be made of copper. For example, in a case where the pipe member 110 is made of copper and the cylinder head main body 101 is made of an aluminum alloy, since the melting point of copper is higher than the melting point of an aluminum alloy, it is possible to further prevent erosion of the thin portion 117a or the like.

What is claimed is:

1. A cylinder head for an internal combustion engine, the cylinder head comprising:
a cylinder head main body in which a plurality of combustion chambers is arranged; and
a pipe member that extends along a direction in which the combustion chambers are arranged, through which a refrigerant flows, the pipe member being embedded in the cylinder head main body, wherein:
the pipe member is provided with a first curved portion that is curved; and
the first curved portion is provided with a first throttle region, a sectional area of the first throttle region being partially reduced.

2. The cylinder head according to claim 1, wherein the combustion chambers include a first combustion chamber which is closest to the first curved portion and the first curved portion is curved to be close to the first combustion chamber.

3. The cylinder head according to claim 2, wherein a first wall portion of the first curved portion is provided with a first thin portion, which faces the first combustion chamber and which is thinner than another portion.

4. The cylinder head according to claim 3, wherein at least a portion of the first thin portion is provided in the first throttle region.

5. The cylinder head according to claim 2, wherein:
the combustion chambers further include a second combustion chamber that is adjacent to the first combustion chamber and that is downstream or upstream of the first combustion chamber in a flowing direction of the refrigerant;
the pipe member is further provided with a second curved portion that is closest to the second combustion chamber;
the second curved portion is provided with a second throttle region; and
a path sectional area at the second throttle region is smaller than a path sectional area at the first throttle region.

6. The cylinder head according to claim 3, wherein:
the combustion chambers further include a second combustion chamber that is adjacent to the first combustion chamber and that is downstream or upstream of the first combustion chamber in a flowing direction of the refrigerant;
the pipe member is further provided with a second curved portion that is closest to the second combustion chambers;
a second wall portion of the second curved portion is provided with a second thin portion which is thinner than the first thin portion.

7. The cylinder head according to claim 2, wherein the first curved portion is positioned between two exhaust ports that communicate with the first combustion chamber, and the second curved portion is positioned between two exhaust ports that communicate with the second combustion chamber.

8. The cylinder head according to claim 2, wherein the first curved portion is positioned between two intake ports that communicate with the first combustion chamber, and the second curved portion is positioned between two intake ports that communicate with the second combustion chamber.

9. The cylinder head according to claim 1, wherein the pipe members include a first pipe member and a second pipe member that are disposed such that an ignition plug is interposed between the first pipe member and the second pipe member in a top view.
